(19) United States
(12) Patent Application Publication
(10) Pub. No.: US 2006/0242846 A1
(43) Pub. Date: Nov. 2, 2006

(54) Pencil sharpener

(75) Inventor: Fritz Luttgens, Erlangen (DE)

Correspondence Address: LERNER GREENBERG STEMER LLP, P O BOX 2480, HOLLYWOOD, FL, 33022-2480, US

(73) Assignee: KUM Limited

(21) Appl. No.: 11/263,160

(22) Filed: Oct. 31, 2005

(30) Foreign Application Priority Data
Apr. 27, 2005 (EP) 05 009 200.6
Apr. 29, 2005 (EP) 05 009 456.4

(51) Int. Cl. B43L 23/00

(52) U.S. Cl. 30/457

(57) ABSTRACT

A pencil sharpener has improved handling. The pencil sharpener has a sharpener body, which defines a pencil-guiding channel and has a blade holder, set at an angle with respect to an axis of the pencil-guiding channel, for a shaving blade. The sharpener body is also provided with at least one gripping area intended for bearing one or more fingers of a hand holding the sharpener body during the sharpening operation. The at least one gripping pad is made of a soft material in comparison with the sharpener body and is provided at least in a subregion of the gripping area.

### BACKGROUND OF THE INVENTION

### Field of the Invention

The invention relates to a pencil sharpener for sharpening a writing or painting implement or a cosmetic pencil.

Conventional pencil sharpeners, as are known for example from German patent DE 668 717 C and published, non-prosecuted German patent application DE 27 43 120 A1, contain a sharpener body, which defines a pencil-guiding channel, and a blade holder, set at an angle with respect to an axis of the pencil-guiding channel, for a shaving blade. To improve the handling of a conventional pencil sharpener, recessed grips are also often provided on mutually opposite sides of the sharpener body, intended for bearing one or more fingers of a hand holding the sharpener body during the sharpening operation. The gripping area formed within such a recessed grip is in this case often provided with a grooved surface, so that the sharpener can be securely gripped without it slipping.

### SUMMARY OF THE INVENTION

It is accordingly an object of the invention to provide a pencil sharpener which overcomes the above-mentioned disadvantages of the prior art devices of this general type, which has improved handling.

With the foregoing and other objects in view there is provided, in accordance with the invention, a pencil sharpener. The pencil sharpener contains a sharpener body having a pencil-guiding channel with an axis, and a blade holder set at an angle with respect to the axis of the pencil-guiding channel. The sharpener body further has at least one gripping area bearing at least one finger of a hand holding the sharpener body during a sharpening operation. A shaving blade is disposed in the blade holder. At least one gripping pad made of a soft material in comparison with a material of the sharpener body is disposed at least in a subregion of the at least one gripping area.

According to the invention, at least one gripping pad, which is formed from a soft material in comparison with the material of the sharpener body, is formed on the gripping area provided on the sharpener body of a pencil sharpener.

One effect achieved by the soft gripping pad or pads is that the sharpener can be gripped particularly securely without it slipping, while at the same time it is then very comfortable to use, in that the pencil sharpener according to the invention is nice to grip because of the soft padding material.

In a preferred embodiment of the invention, the or each gripping area is provided with a gripping pad, which in particular substantially fills the gripping area completely. Alternatively, a number of gripping pads are assigned to the or each gripping area. These gripping pads are, in particular, formed in the manner of strips, so that the gripping pads form a kind of pattern of ridges. Alternatively, the gripping pads are formed in manner of pimples, so that a pattern of dots is formed within the assigned gripping area.

Both the sharpener body and the gripping pad or pads are preferably produced from a plastic material, a comparatively hard plastic being used for the sharpener body and a comparatively soft plastic, in particular an elastomer, being used for the or each gripping pad.

Especially favorable here from a production technology viewpoint is, in particular, a one-piece production of the sharpener body with the or each gripping pad as an injection-molded plastic part, which is produced using a two-component injection-molding process.

The or each gripping area expediently forms a hollow or depression with respect to the surrounding outer area of the sharpener body, in order to improve the ergonomics of the pencil sharpener. The sharpener body also preferably bears two gripping areas disposed approximately diametrically opposite each other, which serve for bearing both the thumb and the index finger of the hand holding the pencil sharpener during sharpening.

According to an advantageous variant, the sharpener body has a shaving-collecting container, on which the respective gripping pad is disposed. The sharpener body is consequently made up of one or more parts containing a basic sharpener body, bearing the shaving blade, and the shaving-collecting container, having the recessed grips or gripping pads on the outer casing or circumference.

In an advantageous refinement of this variant, a constricted shaving-collecting container is provided. In particular for visual, ergonomic or configuration-related reasons, the shaving-collecting container is provided with toroidal or bead-like ribs running around it and lying one on top of the other in the direction of the longitudinal axis of the container, or is configured in this form. The gripping pads are in turn expediently disposed on opposite sides of the shaving-collecting container.

Other features which are considered as characteristic for the invention are set forth in the appended claims.

Although the invention is illustrated and described herein as embodied in a pencil sharpener, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings

### BRIEF DESCRIPTION OF THE DRAWINGS

FIG. 1 is a diagrammatic, perspective view of a first embodiment of the pencil sharpener according to the invention;

FIG. 2 is a sectional view of the pencil sharpener taken along section line II shown in FIG. 1 being a horizontal center plane;

FIG. 3 is a diagrammatic, perspective view of a second embodiment of the pencil sharpener;

FIG. 4 is a sectional view of the pencil sharpener taken along section line IV shown in FIG. 3;

FIG. 5 is a diagrammatic, front view of the pencil sharpener with a sharpener body having a shaving-collecting container; and

FIG. 6 is a diagrammatic, side view of the pencil sharpener with a sharpener body having the shaving-collecting container, and turned through 90° with respect to FIG. 5.

### DESCRIPTION OF THE PREFERRED EMBODIMENTS

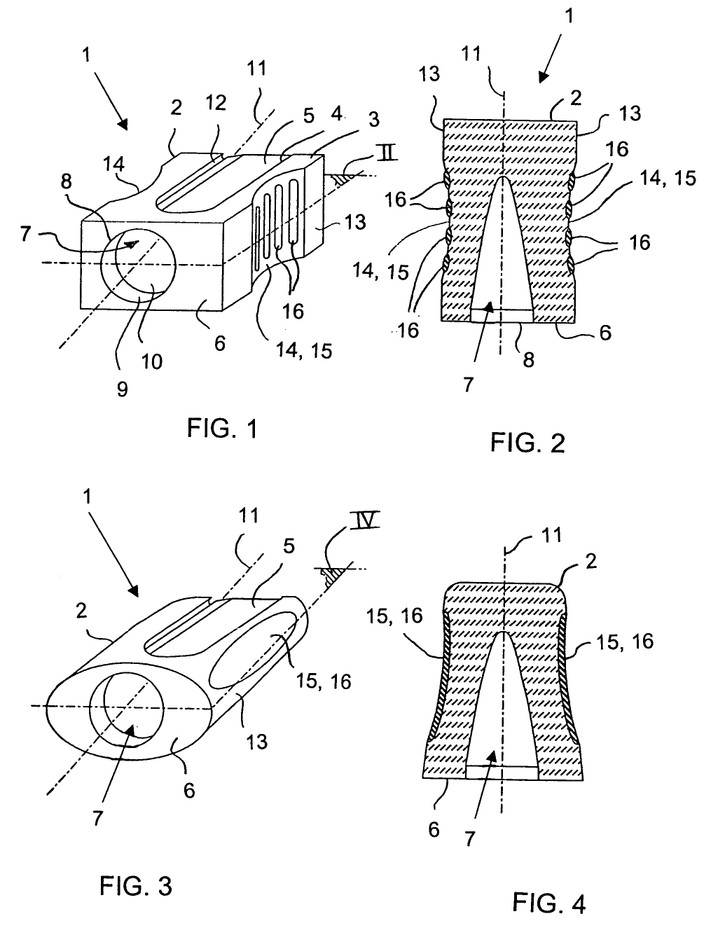

In all the figures of the drawing, sub-features and integral parts that correspond to one another bear the same reference symbol in each case. Referring now to the figures of the drawing in detail and first, particularly, to FIGS. 1 and 2 thereof, there is shown a pencil sharpener 1 which has an approximately cuboidal sharpener body 2 made of a comparatively hard plastic material. The sharpener body 2 has on an upper side 3 a blade holder 4, in which a shaving blade 5 lies approximately parallel to the upper side 3. The shaving blade 5 is fixed in the blade holder 4 by a non-illustrated fastening screw. A pencil-guiding channel 7, which is formed in the manner of a bore within the sharpener body 2 and into which a non-illustrated pencil can be pushed for the sharpening operation, opens out on a front side 6 of the sharpening body 2. In the region of an insertion opening 8, the pencil-guiding channel 7 initially has a cylindrical portion 9. The end of this portion 9 that is remote from the insertion opening 8 is adjoined by a conical portion, which is referred to hereafter as the sharpening cone 10.

With respect to its axis 11, the pencil-guiding channel 7 is aligned at an angle to the base areas of the sharpener body 2, so that the wall of the pencil-guiding channel 7 is approximately at a tangent to the upper side 3 of the sharpener body 2 in the region of the sharpening cone 10. In the region of this tangent, the pencil-guiding channel 7 is open toward the upper side 3 via a cutting slit 12, into which the shaving blade 5 protrudes with a cutting edge. The cutting slit 12 serves in a known way for discharging the shavings of the pencil material shaved off during the sharpening operation.

On two mutually opposite side faces 13, the sharpener body 2 is respectively provided with a recessed grip 14, the area of which that is curved inwardly with respect to the sharpener body 2 defining a gripping area 15. The recessed grips 14 and recessed grips 15 are intended for bearing the thumb and the index finger of a hand holding the sharpener body 2 during the sharpening operation and serve thereby in particular for making the sharpener body 2 better able to be gripped. To improve this gripping even further, the sharpener body 2 bears in the region of each gripping area 15 four gripping pads 16 in the form of small bars or strips. Each gripping pad 16 is formed of a plastic material which is softer than the material of the sharpener body 2, and in particular elastic, and which yields in the manner of a pad when the sharpener body 2 is manually held firmly between the thumb and the index finger. The gripping pads 16 are in this case partially embedded in the material of the sharpener body 2 and protrude above the surface of the sharpener body 2 in the manner of parallel strips. As a result, a soft ribbed structure is formed in the region of the gripping area 15 by the gripping pads 16.

The sharpener body 2 is produced together with the embedded gripping pads 16 as a one-piece part in a two-component injection-molding process.

Instead of gripping pads 16 in the form of small bars or strips, gripping pads in the form of pimples may also be provided.

The gripping areas 15, provided according to the invention with gripping pads 16, may be used on a sharpener body 2 formed in any way desired. A further embodiment of the pencil sharpen 1 that differs from the pencil sharpener 1 described above in particular with regard to the external form of the sharpener body 2 is shown in FIGS. 3 and 4. This embodiment of the pencil sharpener 1 is in turn provided with two gripping areas 15, which flank the shaving blade 5 on both sides and to which there is respectively assigned a single gripping pad 16, in contrast with the exemplary embodiment described above. This gripping pad 16 completely fills the gripping area 15. In other words, the area taken up by the gripping pad 16 forms the gripping area 15. As indicated in FIG. 4, the or each gripping pad 16 may in turn form a hollow. Alternatively, however, the gripping pad 16 may also finish flush with the surrounding outer wall of the sharpener body 2.

In particular in the latter case, for improved handling of the pencil sharpener 1, the or each gripping pad 16 is set visually apart from the sharpener body 2, in particular by being of a different color. In addition or alternatively, the or each gripping pad 16 may be provided with a nonslip surface structure, for example a ribbing or pimpling.

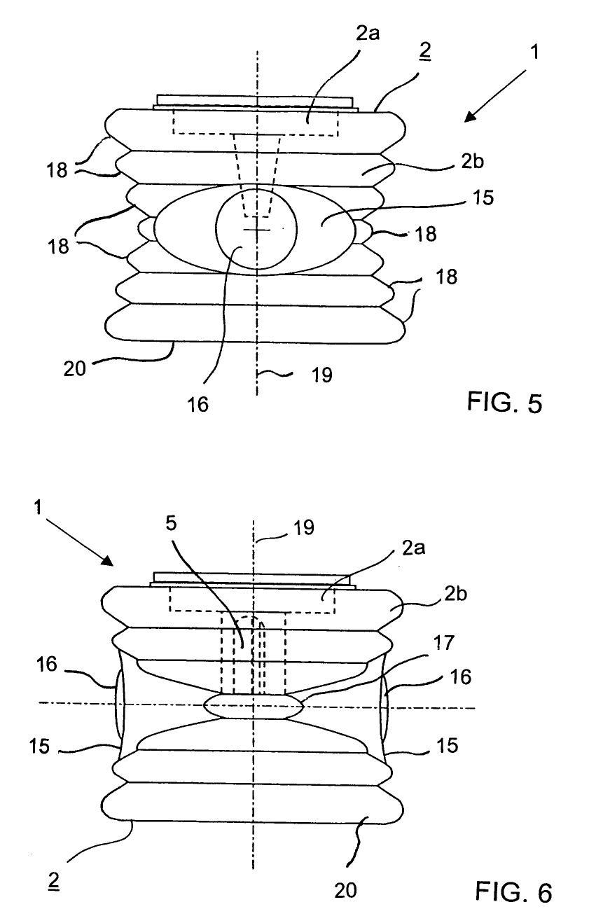

In the exemplary embodiment according to FIGS. 5 and 6,—in a multipart embodiment departing from the exemplary embodiments represented in FIGS. 1 to 4—the sharpener body 2 includes a basic body 2a (or a number of such basic bodies) holding the shaving blade 5 and a shaving-collecting housing 2b, surrounding the basic body (or bodies) and referred to hereafter as the shaving-collecting container. In the case of this embodiment, the gripping pad or pads 16 are provided in particular on the outer circumference of the shaving-collecting container 2b, where they are on mutually opposite gripping areas 15.

In the embodiment shown, the shaving-collecting container 2b has a constricted cylindrical form. In the constricted region 17 of the container, the two gripping areas 15, which in the exemplary embodiment are oval-shaped, are provided on opposite sides of the container. The shaving-collecting container 2b of the sharpener body 2 has a number of ribs, beads or tori 18—lying one on top of the other in the direction of the longitudinal axis 19 of the container. The respective outside diameter of these bead-like ribs 18 decreases—starting from the container base 20—to the constricted, middle container region 17, and from there in turn increases to the same extent.

The gripping pad 16 may be molded in one piece onto the shaving-collecting container 2b. Also—in a multipart embodiment—the gripping pads 16 may be attached to the shaving-collecting container 2b, for example adhesively bonded to it. Moreover, the gripping pads 16 may be formed of the same material as the shaving-collecting container 2b or of a different material.

This application claims the priority, under 35 U.S.C. §119, of European patent application EP 05 009 200.6 filed Apr. 27, 2005 and European patent application EP 05 009 456.4 filed Apr. 29, 2005; the entire disclosure of the prior applications are herewith incorporated by reference.

I claim:

1. A pencil sharpener, comprising:
a sharpener body having a pencil-guiding channel formed therein with an axis, and a blade holder set at an angle with respect to said axis of said pencil-guiding channel, said sharpener body further having at least one gripping area bearing at least one finger of a hand holding said sharpener body during a sharpening operation;
a shaving blade disposed in said blade holder; and
at least one gripping pad made of a soft material in comparison with a material of said sharpener body and disposed at least in a subregion of said at least one gripping area.

2. The pencil sharpener according to claim 1, wherein said at least one gripping pad substantially fills said at least one gripping area.

3. The pencil sharpener according to claim 1, wherein said at least one gripping pad is one of a number of gripping pads in a form of pimples or strips distributed on said at least one gripping area.

4. The pencil sharpener according to claim 1, wherein said sharpener body and said at least one gripping pad are formed of different plastics.

5. The pencil sharpener according to claim 4, wherein said sharpener body is produced together with said at least one gripping pad as a one-piece plastic injection-molded part.

6. The pencil sharpener according to claim 1, wherein said sharpener body has a hollow formed therein in a region of said at least one gripping area.

7. The pencil sharpener according to claim 1, wherein said at least one gripping area is one of two gripping areas disposed approximately diametrically opposite each other.

8. The pencil sharpener according to claim 1, wherein said sharpener body has a shaving-collecting container, on which said at least one gripping pad is disposed.

9. The pencil sharpener according to claim 8, wherein said shaving-collecting container is a cylindrical shaving-collecting container with said at least one gripping pad respectively on opposite sides.

10. The pencil sharpener according to claim 8, wherein said shaving-collecting container is a constricted shaving-collecting container with toroidal or bead-like ribs running around it and lying one on top of one another in a direction of a longitudinal axis of said constricted shaving-collecting container.
